(19) United States
(12) Patent Application Publication
(10) Pub. No.: US 2026/0153756 A1
(43) Pub. Date: Jun. 4, 2026

(54) MODULATION MODULE AND ELECTRONIC DEVICE INCLUDING THE SAME

(71) Applicant: InnoLux Corporation, Miao-Li County (TW)

(72) Inventors: Jen-Hai CHI, Miao-Li County (TW); Chean KEE, Miao-Li County (TW); An-Cheng CHENG, Miao-Li County (TW)

(21) Appl. No.: 19/377,339

(22) Filed: Nov. 3, 2025

Related U.S. Application Data
(60) Provisional application No. 63/726,772, filed on Dec. 2, 2024.

(30) Foreign Application Priority Data
Jun. 26, 2025 (CN) 202510869153.8

(51) Int. Cl. G02F 1/03; G02F 1/00

(52) U.S. Cl. CPC G02F 1/0344; G02F 1/0045; G02F 1/0316; G02F 2203/01

(57) ABSTRACT

An electronic device includes: a frame including an accommodation space and a frame groove arranged to be adjacent to the accommodation space; a signal connection element disposed in the frame groove; and a modulation module disposed in the accommodation space. The modulation module includes: a first carrier board; a second carrier board corresponding to the first carrier board; an electromagnetic wave receiving element disposed on at least one of the first carrier board and the second carrier board; and an electromagnetic wave adjusting element disposed between the first carrier board and the second carrier board. The electromagnetic wave receiving element is electrically connected to the signal connection element in the frame groove.

### CROSS-REFERENCE TO RELATED APPLICATIONS

This application claims the benefit of filing date of U.S. Provisional Application Ser. No. 63/726,772 filed on Dec. 2, 2024 under 35 USC § 119(e)(1), and also claims the benefit of the Chinese Patent Application Serial Number 202510869153.8, filed on Jun. 26, 2025, the subject matters of which are incorporated herein by reference.

### BACKGROUND

### Field of the Disclosure

The present disclosure provides a modulation module and an electronic device including the same.

### Description of Related Art

Smart glass or smart window, also known as liquid crystal window, has been developed for many years and is widely used in many fields such as smart buildings, energy conservation and environmental protection, and privacy protection. It refers to a device that can change the light transmittance of glass or windows by controlling the arrangement of dyes to follow the liquid crystals, so as to switch the glass or window to present a transparent state, a dark state (discoloration state), a haze state, etc., so as to achieve dimming and/or heat insulation effects, such as reducing energy consumption of air conditioning while taking bright vision into account.

However, with the change of communication technology, 5G signals have gradually developed towards high-frequency signals, which are prone to attenuation after passing through buildings. In addition, the transparent electrode layer in the smart glass or smart window may shield the signal of the communication device, causing the high-frequency signal to attenuate greatly. Therefore, it is still necessary to overcome the problem of poor indoor signal.

Therefore, it is desired to provide an improved modulation module and an electronic device including the same to alleviate and/or obviate the above defects.

### SUMMARY

The present disclosure provides an electronic device, which includes: a frame including an accommodation space and a frame groove arranged to be adjacent to the accommodation space; a signal connection element disposed in the frame groove; and a modulation module disposed in the accommodation space, and including: a first carrier board; a second carrier board corresponding to the first carrier board; an electromagnetic wave receiving element disposed on at least one of the first carrier board and the second carrier board; and an electromagnetic wave adjusting element disposed between the first carrier board and the second carrier board, wherein the electromagnetic wave receiving element is electrically connected to the signal connection element in the frame groove.

The present disclosure further provides a modulation module, which includes: a first carrier board; a second carrier board corresponding to the first carrier board; a liquid crystal layer disposed between the first carrier board and the second carrier board; an electromagnetic wave receiving element including a first pattern layer; and a ground layer corresponding to the first pattern layer, wherein the first pattern layer is disposed on the first carrier board, and the ground layer is closer to the liquid crystal layer than the first pattern layer.

Other novel features of the disclosure will become more apparent from the following detailed description when taken in conjunction with the accompanying drawings.

### BRIEF DESCRIPTION OF DRAWINGS

FIG. 1 is a schematic diagram of an electronic device according to an embodiment of the present disclosure;

FIG. 2 is a cross-sectional schematic diagram of an electronic device according to an embodiment of the present disclosure;

FIG. 3 is a schematic top view of an electronic device according to an embodiment of the present disclosure;

FIG. 4 is a cross-sectional schematic diagram of a modulation module according to another embodiment of the present disclosure;

FIG. 5 is a cross-sectional schematic diagram of a modulation module according to another embodiment of the present disclosure;

FIG. 6 is a cross-sectional schematic diagram of a modulation module according to another embodiment of the present disclosure;

FIG. 7 is a cross-sectional schematic diagram of a modulation module according to another embodiment of the present disclosure;

FIG. 8 is a cross-sectional schematic diagram of a modulation module according to another embodiment of the present disclosure;

FIG. 9 is a cross-sectional schematic diagram of a modulation module according to another embodiment of the present disclosure;

FIG. 10 is a cross-sectional schematic diagram of a modulation module according to another embodiment of the present disclosure; and

FIG. 11 is a cross-sectional schematic diagram of a modulation module according to another embodiment of the present disclosure.

### DETAILED DESCRIPTION OF EMBODIMENT

The electronic device according to the embodiment of the present disclosure is described in detail below. It should be understood that the following description provides many different embodiments for implementing different aspects of some embodiments of the present disclosure. The specific components and arrangements described below are only for the purpose of simply and clearly describing some embodiments of the present disclosure. Of course, these are only examples and are not limitations of the present disclosure. In addition, similar and/or corresponding reference numerals may be used in different embodiments to identify similar and/or corresponding components in order to clearly describe the present disclosure. However, the use of these similar and/or corresponding reference numerals is only for simply and clearly describing some embodiments of the present disclosure, and does not represent any relationship between the different embodiments and/or structures discussed.

The embodiments of the present disclosure may be understood together with the drawings, and the drawings of the present disclosure are also regarded as part of the disclosure description. It should be understood that the drawings of the present disclosure are not in scale and, in fact, the dimensions of elements may be arbitrarily enlarged or reduced in order to clearly illustrate features of the present disclosure. In addition, directional terms mentioned in the specification, such as “up”, “down”, “front”, “rear”, “left”, “right”, etc., only refer to the directions of the drawings. Accordingly, the directional term used is illustrative, not limiting, of the present disclosure. In the drawings, various figures illustrate the general characteristics of methods, structures and/or materials used in particular embodiments. However, these drawings should not be construed to define or limit the scope or nature encompassed by these embodiments. For example, the relative sizes, thicknesses and positions of various layers, regions and/or structures may be reduced or enlarged for clarity.

One structure (or layer, component, substrate) described in the present disclosure is disposed on/above another structure (or layer, component, substrate), which can mean that the two structures are adjacent and directly connected, or can refer to two structures that are adjacent rather than directly connected. Indirect connection means that there is at least one intermediate structure (or intermediate layer, intermediate component, intermediate substrate, intermediate space) between the two structures, the lower surface of one structure is adjacent to or directly connected to the upper surface of the intermediate structure, and the upper surface of the other structure is adjacent to or directly connected to the lower surface of the intermediate structure. The intermediate structure may be a single-layer or multi-layer physical structure or a non-physical structure, which is not limited. In the present disclosure, when a certain structure is arranged “on” other structures, it may mean that a certain structure is “directly” on other structures, or it means that a certain structure is “indirectly” on other structures; that is, at least one structure is sandwiched, in between a certain structure and other structures.

In addition, it should be understood that, unless otherwise specified, the ordinal numbers used in the specification and claims, such as “first” and “second”, are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

In some embodiments of the present disclosure, terms such as “connection” and “interconnection” about joining and connecting, unless otherwise specified, may mean that two structures are in direct contact, or may also mean that two structures are not in direct contact, where other structures are placed between the two structures. Moreover, the terms about joining and connecting may also include the situation that both structures are movable, or both structures are fixed. In addition, the term “electrical connection” or “coupling” includes any direct and indirect means of electrical connection.

In the description, the terms “almost”, “about”, “approximately” or “substantially” usually means within 10%, 5%, 3%, 2%, 1% or 0.5% of a given value or range. Unless otherwise defined, the term “range between the first value and the second value” indicates that the range includes the first value, the second value, and other values in between. Moreover, any two values or directions used for comparison may have certain errors. If the first value is equal to the second value, it implies that there may be an error of about 10% between the first value and the second value; if the first direction is perpendicular or “approximately” perpendicular to the second direction, the angle between the first direction and the second direction may be between 80 degrees and 100 degrees; if the first direction is parallel or “substantially” parallel to the second direction, the angle between the first direction and the second direction may be between 0 degrees and 10 degrees. In the present disclosure, the expressions “the given range is from the first value to the second value” and “the given range falls within the range from the first value to the second value” indicate that the given range includes the first value, the second value, and other values in between.

Furthermore, according to the embodiments of the present disclosure, an optical microscope (OM), a scanning electron microscope (SEM), a thin film thickness profiler (α-step), an ellipsometer, or other suitable methods may be used to measure the thickness, length, width of each component or the distance and angle between components. In detail, according to some embodiments, a scanning electron microscope may be used to obtain a cross-sectional image of a structure and measure the thickness, length, width of each component or the distance and angle between components.

In the entire specification and appended claims of the present disclosure, certain words are used to refer to specific components. Those skilled in the art should understand that electronic device manufacturers may refer to the same components by different names. The present disclosure does not intend to distinguish those components with the same function but different names. In the following description and claims, words such as “comprising”, “including”, and “having” are open type words, so they should be interpreted as meaning “including but not limited to”. Therefore, when the terms “comprising”, “including” and/or “having” are used in the description of the present disclosure, they specify the existence of corresponding features, regions, steps, operations and/or components, but do not exclude the existence of one or more corresponding features, regions, steps, operations and/or components.

It should be understood that, without departing from the spirit of the present disclosure, in the following embodiments, the features in different embodiments may be replaced, reorganized or mixed to accomplish other embodiments. The features among various embodiments may be mixed and matched arbitrarily as long as they do not violate the spirit of the invention or conflict with each other.

Unless otherwise defined, all terms (including technical and scientific terms) used herein have the same meaning as commonly understood by one of ordinary skill in the art to which this disclosure belongs. It may be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure. The present disclosure may be understood by referring to the following detailed description in conjunction with the accompanying drawings. It should be noted that, in order to facilitate the understanding of the readers and for the simplicity of the drawings, the multiple drawings in the present disclosure only depict a portion of the electronic device, and the specific components in the drawings are not drawn according to the actual scale. In addition, the number and size of each component in the figure are only for illustration and are not intended to limit the scope of the present disclosure.

The electronic device of the present disclosure may include electronic components. The electronic components may include passive components, active components, or a combination thereof, such as capacitors, resistors, inductors, varactor diodes, variable capacitors, filters, diodes, transistors, sensors, micro-electromechanical system (MEMS) components, liquid crystal chips, etc., but not limited thereto. The diode may include a light-emitting diode or a non-light-emitting diode. The diode includes a P-N junction diode, a PIN diode, or a constant current diode. The light-emitting diode may, for example, include an organic light emitting diode (OLED), a sub-millimeter light-emitting diode (mini LED), a micro LED, a quantum dot light-emitting diode (quantum dot LED), fluorescence, phosphor, or other suitable materials, or a combination thereof, but not limited thereto. The sensor may include, for example, capacitive sensors, optical sensors, electromagnetic sensors, fingerprint sensors (FPS), touch sensors, antennas, or pen sensors, but not limited thereto. The following description will use a display device as an electronic device to illustrate the disclosure, but not limited thereto.

The electronic device may include an imaging device, a bonding device, a display device, a backlight device, an antenna device, a tiled device, a touch display, a curved display or a free shape display, but not limited thereto. The electronic device may, for example, include a liquid crystal, a light emitting diode, fluorescence, phosphor, other suitable display media, or a combination thereof, but not limited thereto. The display device may be a non-self-luminous display device or a self-luminous display device. The antenna device may be a liquid crystal antenna device or a non-liquid crystal antenna device, and the sensing device may be a sensing device for sensing capacitance, light, heat or ultrasound, but not limited thereto. The tiled device may, for example, be a display tiled device or an antenna tiled device, but not limited thereto. It should be noted that the electronic device may be any combination of the foregoing, but not limited thereto. The electronic device may be a bendable or flexible electronic device. It should be noted that the electronic device may be any arrangement or combination of the aforementioned, but not limited thereto. In addition, the appearance of the electronic device may be rectangular, circular, polygonal, a shape with curved edges, or other suitable shapes. The electronic device may have a peripheral system such as a drive system, a control system, a light source system, a shelf system, etc. to support a display device, an antenna device, or a tiled device. It should be noted that, in the following embodiments, the features of several different embodiments may be replaced, reorganized, and mixed to complete other embodiments without departing from the spirit of the present disclosure. The features of each embodiment may be mixed and matched as much as they do not violate the spirit of the disclosure or conflict with each other. It should be noted that the technical solutions provided in the different embodiments below may be replaced, combined, or mixed with each other to form another embodiment without violating the spirit of the present disclosure.

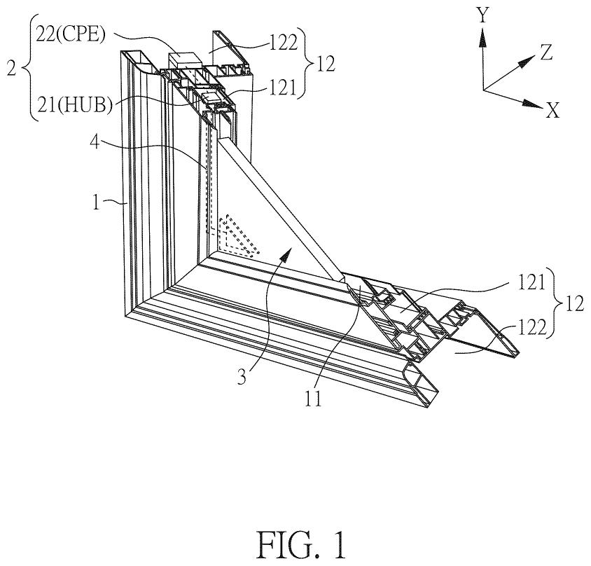

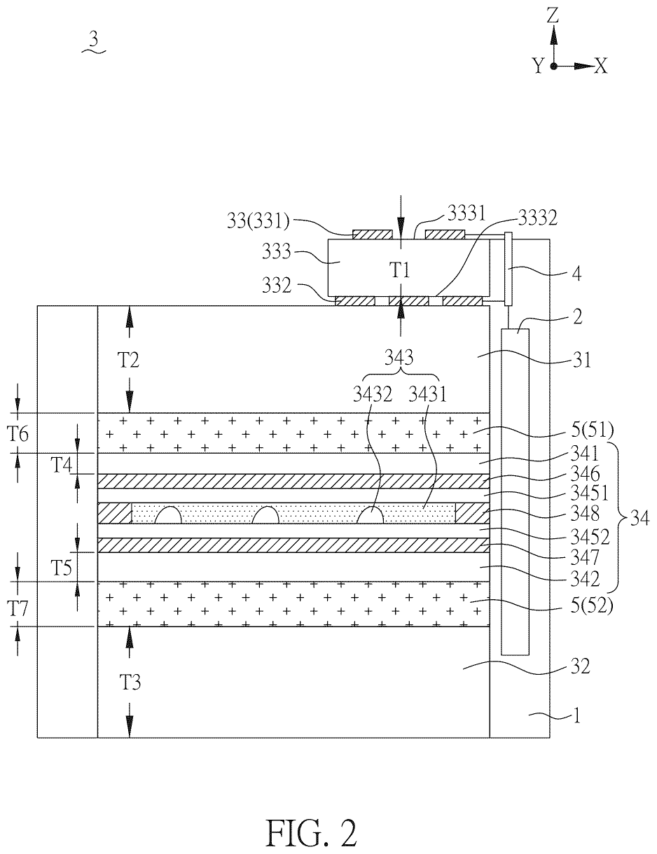

FIG. 1 is a schematic diagram of an electronic device according to an embodiment of the present disclosure. FIG. 2 is a cross-sectional schematic diagram of an electronic device according to an embodiment of the present disclosure. For the convenience of explanation, only a portion of the electronic device is shown in FIG. 1, and some components are omitted in FIG. 2. In one embodiment of the present disclosure, as shown in FIG. 1 and FIG. 2, the electronic device includes a frame 1, a signal connection element 2, and a modulation module 3. The frame 1 is in a square shape and includes an accommodation space 11 and a frame groove 12 adjacent to the accommodation space 11, wherein the accommodation space 11 is adjacent to the inner side of the frame 1, and the frame groove 12 is adjacent to the outer side of the frame 1 relative to the accommodation space 11. The signal connection element 2 is disposed in the frame groove 12. When observed from the Z-axis direction, the signal connection element 2 is hidden in the frame groove 12 of the frame 1, which may achieve an aesthetic effect. In addition, the modulation module 3 is disposed in the accommodation space 11. Specifically, the modulation module 3 has a periphery to be embedded in the accommodation space 11 of the frame 1, and includes a first carrier board 31, a second carrier board 32, an electromagnetic wave receiving element 33 and an electromagnetic wave adjusting element 34, and the second carrier board 32 corresponds to the first carrier board 31. Electromagnetic waves include visible light or invisible light. In some embodiments, electromagnetic waves may have frequencies between 410 MHz and 300 GHz, between 7.125 GHz and 24 GHz, between 24 GHz and 71 GHz, or between 92 GHz and 300 GHz. In the present disclosure, the first carrier board 31 is close to the outdoor side, the second carrier board 32 is close to the indoor side, and the first carrier board 31 and the second carrier board 32 are, for example, two side substrates of the modulation module 3. In addition, the electromagnetic wave receiving element 33 is disposed on at least one of the first carrier board 31 and the second carrier board 32. In the present disclosure, the electromagnetic wave receiving element 33 is disposed on the first carrier board 31, while it is not limited thereto, and the electromagnetic wave receiving element 33 may also be disposed on the second carrier board 32. Furthermore, the electromagnetic wave adjusting element 34 is disposed between the first carrier board 31 and the second carrier board 32, and the electromagnetic wave receiving element 33 is electrically connected to the signal connecting element 2 in the frame groove 12.

As shown in FIG. 1 and FIG. 2, the electronic device may further include a conductive wire 4, which is disposed in the electronic device. The conductive wire 4 may pass through the frame 1 to connect the signal connection element 2 and the electromagnetic wave receiving element 33, so that the signal received by the electromagnetic wave receiving element 33 may be transmitted to the signal connection element 2 via the conductive wire 4. The electromagnetic wave receiving element 33 is adjacent to the outside, so that the signal does not need to pass through the building or will not be shielded by the electrode layer in the electromagnetic wave adjusting element 34, and has excellent signal attenuation resistance for ensuring signal quality, thereby improving the signal strength and stability indoors. In addition, the electromagnetic wave receiving element 33 may include a first pattern layer 331, which may be disposed on the first carrier board 31, and the first pattern layer 331 may be connected to the conductive wire 4, and may be connected to the signal connection element 2 through the conductive wire 4. Furthermore, the electromagnetic wave receiving element 33 or the modulation module 3 may include a ground layer 332, and the ground layer 332 may be connected to the conductive wire 4, and may be connected to the signal connection element 2 through the conductive wire 4. Specifically, the first pattern layer 331 and the ground layer 332 each may be connected to the conductive wire 4, and each may be connected to the signal connection element 2 through the conductive wire 4. Here, connection refers to direct connection, while it is not limited thereto, and may also refer to indirect connection. In some embodiments, the ground layer 332 may be a portion of the electromagnetic wave receiving element 33, and is combined with the first pattern layer 331 to constitute the electromagnetic wave receiving element 33. In some embodiments, the ground layer 332 may be a portion of the modulation module 3, and cooperates with the first pattern layer 331 to achieve the same function as the electromagnetic wave receiving element 33. Therefore, the first pattern layer 331 and the ground layer 332 are not limited to an independently composed component (for example, the electromagnetic wave receiving element 33), and may be located at any position of the modulation module 3 as long as the function of electromagnetic wave reception can be achieved.

As shown in FIG. 1 and FIG. 2, the modulation module 3 may further include an adhesive layer 5, which may be selectively disposed between the first carrier board 31 and the electromagnetic wave adjusting element 34 and/or between the electromagnetic wave adjusting element 34 and the second carrier board 32. In the present disclosure, the adhesive layer 5 may include a first adhesive layer 51 and a second adhesive layer 52, wherein the first adhesive layer 51 may be disposed between the first carrier board 31 and the electromagnetic wave adjusting element 34, and the second adhesive layer 52 may be disposed between the electromagnetic wave adjusting element 34 and the second carrier board 32. Specifically, the electromagnetic wave adjusting element 34 may be disposed between the first adhesive layer 51 and the second adhesive layer 52. The first adhesive layer 51 may have a thickness T6 in the Z direction, and the second adhesive layer may have a thickness T7 in the Z direction, wherein the thickness T6 and the thickness T7 each may be approximately 0.76 mm, approximately 1.52 mm, or approximately a multiple of 0.76 mm.

As shown in FIG. 2, the modulation module 3 may further include a modulation carrier board 333, which may be selectively disposed between the first pattern layer 331 and the ground layer 332. In some embodiments, the modulation carrier board 333 may be a portion of the electromagnetic wave receiving element 33, and combined with the first pattern layer 331 to constitute the electromagnetic wave receiving element 33. In some embodiments, the modulation carrier board 333 may be a portion of the modulation module 3, and cooperate with the first pattern layer 331 to achieve the function of receiving the signal frequency to be received by the electromagnetic wave receiving element 33. Therefore, the first pattern layer 331 and the modulation carrier board 333 are not limited to an independently composed component (for example, the electromagnetic wave receiving element 33), and may be located at any position of the modulation module 3, as long as the function of receiving the signal frequency to be received by the electromagnetic wave receiving element 33 can be achieved. In addition, the modulation carrier board 333 may have a thickness T1 in the Z direction, that is, the shortest distance between the top surface 3331 and the bottom surface 3332 of the modulation carrier board 333, and the thickness T1 may be between 2 mm and 10 mm, for example, between 3 mm and 8 mm, about 3 mm, about 4 mm, about 5 mm, about 6 mm, about 7 mm, or about 8 mm. The thickness T1 is the average thickness of the modulation carrier board 333 in the Z direction (for example, the average thickness of three locations thereof), which depends on the signal frequency to be received by the modulation module 3 and the dielectric constant of the material of the first pattern layer 331. In addition, the loss factor (D_{K}) of the material of the modulation carrier board 333 may be smaller than 0.02, and the modulation carrier board 333 may be, for example, a glass substrate or a plastic substrate.

As shown in FIG. 1 and FIG. 2, the frame groove 12 may include a first sub-frame groove 121 and a second sub-frame groove 122, and the signal connection element 2 may include a first sub-device 21 and a second sub-device 22. The first sub-device 21 may be disposed in the first sub-frame groove 121, and the second sub-device 22 may be disposed in the second sub-frame groove 122. In the present disclosure, the first sub-frame groove 121 is disposed between the accommodation space 11 and the second sub-frame groove 122, and the accommodation space 11, the first sub-frame groove 121 and the second sub-frame groove 122 are sequentially arranged from the internal side to the external side of the frame 1. In addition, in the present disclosure, the first sub-device 21 is a hub (HUB), and the second sub-device 22 is a customer premise equipment (CPE), wherein the first pattern layer 331 and the ground layer 332 of the modulation module 3 may be connected to the hub (HUB) via the conductive wire 4, respectively, and then connected to the customer premise equipment (CPE). Thus, the first pattern layer 331 may be used to receive signals (such as 5G or other frequency signals), which are controlled by the hub (HUB) to determine whether to transmit the signal to the customer premise equipment (CPE). After receiving the signal, the customer premise equipment (CPE) may convert it into a wireless signal (such as a WiFi signal or other suitable signals, etc.). In the present disclosure, the hub (HUB) is connected to one customer premise equipment (CPE), but it is not limited thereto. The hub (HUB) may also be connected to multiple customer premise equipment (CPE) located in different rooms or spaces. In addition, in the present disclosure, the hub (HUB) and the customer premise equipment (CPE) are, for example, two separate devices connected to each other, but it is not limited thereto. The hub (HUB) may also be integrated into the customer premise equipment (CPE) so as to be integrated into a single device.

As shown in FIG. 2, the modulation module 3 includes a first carrier board 31, a second carrier board 32, a liquid crystal layer 343 and an electromagnetic wave receiving element 33. The second carrier board 32 corresponds to the first carrier board 31. The liquid crystal layer 343 is disposed between the first carrier board 31 and the second carrier board 32. The electromagnetic wave receiving element 33 includes a first pattern layer 331 and a ground layer 332. The first pattern layer 331 is disposed on the first carrier board 31, and the ground layer 332 is closer to the liquid crystal layer 343 than the first pattern layer 331. In some embodiments, the electromagnetic wave adjusting element 34 includes the liquid crystal layer 343, the third carrier board 341 and the fourth carrier board 342, and the thickness of the third carrier board 341 or the fourth carrier board 342 may be smaller than the thickness of the first carrier board 31 or the second carrier board 32, but it is not limited thereto. Here, the thickness T2 of the first carrier board 31 refers to the average thickness of the first carrier board 31 in the Z direction (for example, the average thickness of three locations thereof), the thickness T3 of the second carrier board 32 refers to the average thickness of the second carrier board 32 in the Z direction (for example, the average thickness of three locations thereof), the thickness T4 of the third carrier board 341 refers to the average thickness of the third carrier board 341 in the Z direction (for example, the average thickness of three locations thereof), and the thickness T5 of the fourth carrier board 342 refers to the average thickness of the fourth carrier board 342 in the Z direction (for example, the average thickness of three locations thereof). The thickness T2, the thickness T3, the thickness T4, and the thickness T5 each may be between 2 mm and 10 mm, for example, between 3 mm and 8 mm, about 3 mm, about 4 mm, about 5 mm, about 6 mm, about 7 mm, or about 8 mm.

In addition, as shown in FIG. 2, the modulation module 3 may further include an electromagnetic wave adjusting element 34, and the electromagnetic wave adjusting element 34 may further include a third carrier board 341 and a fourth carrier board 342. The fourth carrier board 342 may correspond to the third carrier board 341. The third carrier board 341 and the fourth carrier board 342 may be disposed between the first carrier board 31 and the second carrier board 32, and the liquid crystal layer 343 may be disposed between the third carrier board 341 and the fourth carrier board 342. The liquid crystal layer 343 may further include a liquid crystal material 3431 and a liquid crystal spacer 3432. The liquid crystal spacer 3432 is disposed in the liquid crystal layer 343. Specifically, the liquid crystal spacer 3432 is dispersed in the liquid crystal material 3431. The liquid crystal material 3431 may be pre-tilted at an angle by disposing the liquid crystal spacer 3432 to accelerate the response time of the liquid crystal. In addition, the electromagnetic wave adjusting element 34 may further include a first electrode layer 346 and a second electrode layer 347, wherein the first electrode layer 346 may be disposed between the third carrier board 341 and the liquid crystal layer 343, and the second electrode layer 347 may be disposed between the liquid crystal layer 343 and the fourth carrier board 342. Therefore, the liquid crystal layer 343 drives the liquid crystal material 3431 therein for arrangement by an electric field generated by a voltage applied between the first electrode layer 346 and the second electrode layer 347, so as to change its state (the angle of rotation of the liquid crystal material 3431), thereby achieving a dimming effect. In the present disclosure, the liquid crystal material 3431 may include a guest host type liquid crystal (GHLC), or a liquid crystal material capable of switching haze and transmittance, such as a polymer-dispersed liquid crystal (PDLC), a polymer network liquid crystal (PNLC), a cholesteric liquid crystal or other suitable liquid crystals, but it is not limited thereto.

As shown in FIG. 2, the electromagnetic wave adjusting element 34 may further include a first alignment film 3451 and a second alignment film 3452. The first alignment film 3451 may be disposed between the third carrier board 341 and the liquid crystal layer 343, and the second alignment film 3452 may be disposed between the liquid crystal layer 343 and the fourth carrier board 342. Specifically, the first alignment film 3451 may be disposed between the first electrode layer 346 and the liquid crystal layer 343, and the second alignment film 3452 may be disposed between the liquid crystal layer 343 and the second electrode layer 347. In addition, the first alignment film 3451 has a first rubbing direction (not shown), and the second alignment film 3452 has a second rubbing direction (not shown). The first rubbing direction and the second rubbing direction respectively refer to the directions of the mechanically oriented brushing films on the first alignment film 3451 and the second alignment film 3452, so as to achieve the effect of liquid crystal alignment, but it is not limited thereto. The first alignment film 3451 and the second alignment film 3452 may also be optical alignment films.

As shown in FIG. 2, the electromagnetic wave adjusting element 34 may further include a frame glue 348, and the frame glue 348 may be arranged between the third carrier board 341 and the fourth carrier board 342. For example, a portion of the frame glue 348 may be arranged between the first alignment film 3451 and the second alignment film 3452 and may surround the liquid crystal layer 343, so that the liquid crystal material 3431 in the liquid crystal layer 343 is arranged in the space formed by the first alignment film 3451, the second alignment film 3452 and the frame glue 348, but it is not limited thereto.

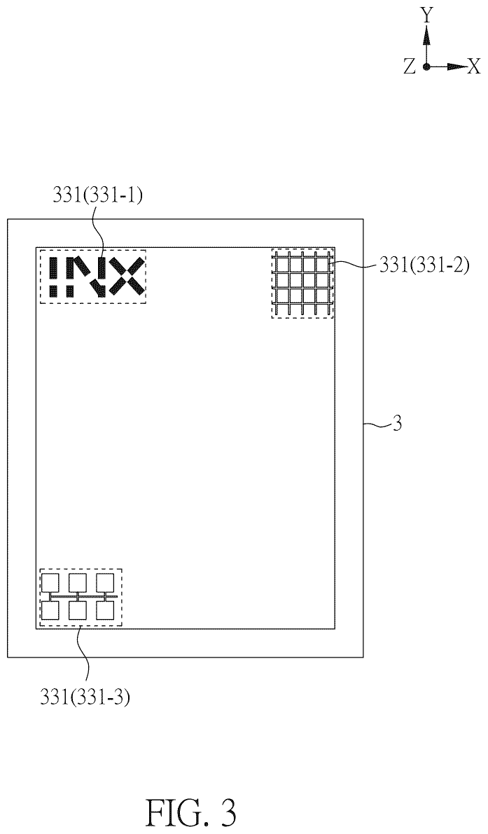

FIG. 3 is a schematic top view of an electronic device according to an embodiment of the present disclosure.

In one embodiment of the present disclosure, as shown in FIG. 3, when the first pattern layer 331 is used to design and arrange a specific logo or pattern, the first pattern layer (for example, 331-1) may be, for example, disposed at a corner of the modulation module 3 to serve as a logo or pattern without affecting the display of the electronic device, but the present disclosure is not limited thereto. In other embodiments, although not shown in the figure, the first pattern layer 331 may also be disposed on the entire surface.

In one embodiment of the present disclosure, as shown in FIG. 3, the first pattern layer (for example, 331-2) may be a metal mesh design. In one embodiment of the present disclosure, as shown in FIG. 3, the first pattern layer (for example, 331-3) may be in the form of a patch. In addition, although not shown in the figure, the first pattern layer (for example, 331-2) may be a metal mesh with small holes, or the first metal pattern (for example, 331-3) may be in the form of a patch with small holes. The metal mesh may have mesh openings of other shapes or mesh openings of different sizes. The patch form may be designed with different patterns according to requirements. Since the small holes (not shown) are dispersed in various areas of the first pattern layer 331, the light transmittance of the electronic device may be further improved. In the present disclosure, the form, size, and setting position of the first pattern layer 331 may be adjusted according to actual requirements or designs.

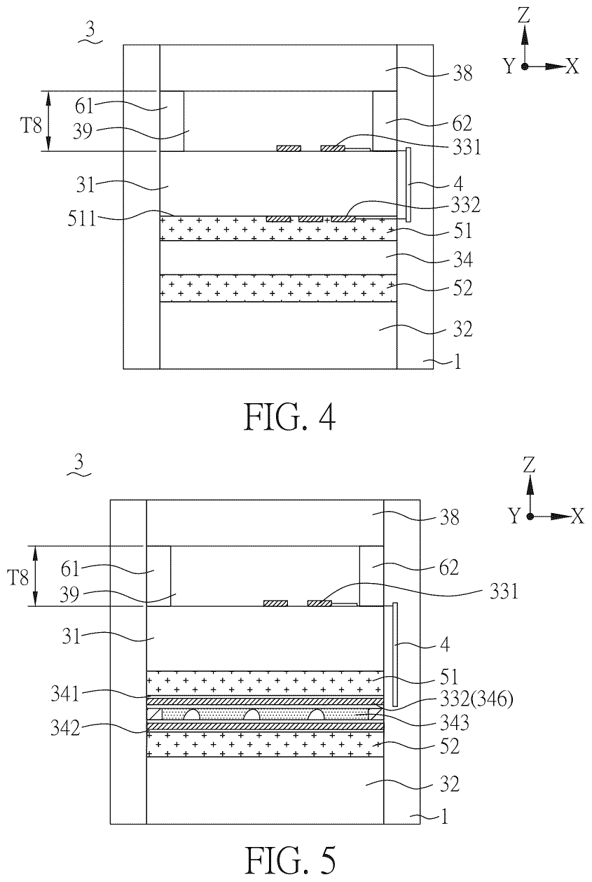

FIG. 4 is a cross-sectional schematic diagram of a modulation module according to another embodiment of the present disclosure, wherein the modulation module of FIG. 4 is similar to that of FIG. 2 except for the following differences. In addition, for the convenience of description, some detail structures of the electromagnetic wave adjusting element 34 of FIG. 4 are omitted, and the details may be referred to FIG. 2.

The first pattern layer 331 of the modulation module 3 according to the embodiment of FIG. 4 may be disposed on one side of the first carrier board 31 board relative to the electromagnetic wave adjusting element 34, and the ground layer 332 may be disposed on the other side of the first carrier board 31 adjacent to the electromagnetic wave adjusting element 34. Specifically, the first carrier board 31 may be disposed between the first pattern layer 331 and the ground layer 332. In the present disclosure, the ground layer 332 may be disposed in the first adhesive layer 51. In some embodiments, the material of the first carrier board 31 may be selected or the thickness of the first carrier board 31 may be adjusted according to the frequency of the signal to be received.

In one embodiment of the present disclosure, as shown in FIG. 4, the modulation module 3 may selectively further include a fifth carrier board 38, wherein the first carrier board 31 may be disposed between the fifth carrier board 38 and the second carrier board 32 and the fifth carrier board 38 and the first carrier board 31 may define a cavity 39, so that the first pattern layer 331 may be protected by the first carrier board 31 and the fifth carrier board 38, thereby providing integrity and aesthetics or preventing the first pattern layer 331 and the ground layer 332 from being oxidized or corroded, so as to increase the product life. Here, the first pattern layer 331 and the ground layer 332 may be disposed on two corresponding sides of the first carrier board 31, but it is not limited thereto. In addition, as shown in FIG. 4, the modulation module 3 may further include a first sealing member 61 and a second sealing member 62, and the cavity 39 may be formed by being surrounded by the first carrier board 31, the fifth carrier board 38, the first sealing member 61 and the second sealing member 62. The first sealing member 61 and the second sealing member 62 may have a thickness T8 in the Z direction, and the thickness T8 may be between 6 mm and 12 mm, such as about 6 mm, about 8 mm, about 10 mm, or about 12 mm. In the present disclosure, the material of the first sealing member 61 and the second sealing member 62 may include aluminum or other suitable materials, but it is not limited thereto.

In one embodiment of the present disclosure, although not shown in the figure, the ground layer 332 of the modulation module 3 may be disposed between the first carrier board 31 and the first adhesive layer 51, and the ground layer 332 may be integrally disposed, which means that the ground layer 332 is disposed on the entire top surface 511 of the first adhesive layer 51.

FIG. 5 is a cross-sectional schematic diagram of a modulation module according to another embodiment of the present disclosure. The modulation module of FIG. 5 is similar to that of FIG. 2 except for the following differences. In addition, for the convenience of explanation, some detailed structures of the electromagnetic wave adjusting element 34 of FIG. 5 are omitted, and the details may be referred to FIG. 2.

The ground layer 332 of the modulation module 3 according to the embodiment of FIG. 5 may be disposed between the liquid crystal layer 343 and the third carrier board 341. Specifically, the first electrode layer 346 of the electromagnetic wave adjusting element 34 is used as the ground layer 332 of the modulation module 3, thereby reducing the production of one electrode layer, thereby reducing the cost. In addition, the area of the ground layer 332 may be the same as the area of the third carrier board 341, but it is not limited thereto. Here, the area of the ground layer 332 refers to the area projected onto the third carrier board 341. In some embodiments, the width of the first carrier board 31 in the X-axis direction is greater than the width of the third carrier board 341 in the X-axis direction, so the area of the ground layer 332 (first electrode layer 346) will be smaller than the area of the first carrier board 31.

In one embodiment of the present disclosure, as shown in FIG. 5, the modulation module 3 may selectively further include a fifth carrier board 38, wherein the first carrier board 31 may be disposed between the fifth carrier board 38 and the second carrier board 32, and the fifth carrier board 38 and the first carrier board 31 may define a cavity 39, so that the first pattern layer 331 may be protected by the first carrier board 31 and the fifth carrier board 38, so as to provide integrity and aesthetics or prevent the first pattern layer 331 and the ground layer 332 from being oxidized or corroded, thereby increasing the product life. In addition, the modulation module 3 may further include a first sealing member 61 and a second sealing member 62, and the cavity 39 may be formed by being surrounded by the first carrier board 31, the fifth carrier board 38, the first sealing member 61 and the second sealing member 62. The first sealing member 61 and the second sealing member 62 may each have a thickness T8 in the Z direction, and the thickness T8 may be between 6 mm and 12 mm, for example, about 6 mm, about 8 mm, about 10 mm or about 12 mm. In the present disclosure, the materials of the first sealing member 61 and the second sealing member 62 may include aluminum or other suitable materials, but it is not limited thereto.

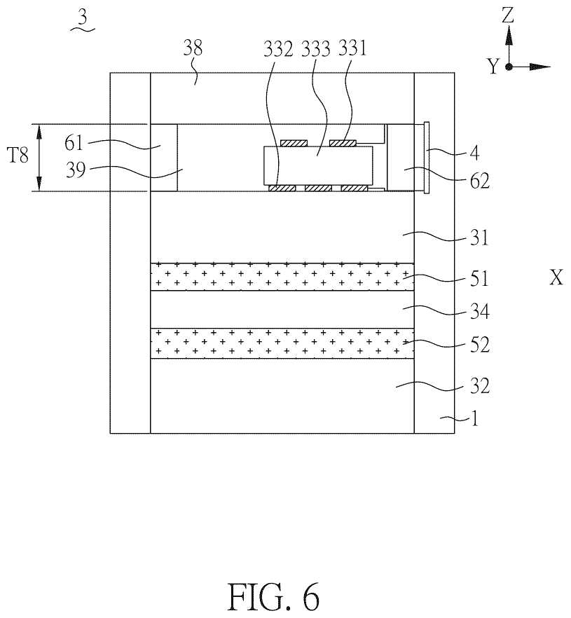

FIG. 6 is a cross-sectional schematic diagram of a modulation module according to another embodiment of the present disclosure. The modulation module of FIG. 6 is similar to that of FIG. 2 except for the following differences. In addition, for the convenience of explanation, some detailed structures of the electromagnetic wave adjusting element 34 of FIG. 6 are omitted, and the details may be referred to FIG. 2.

In one embodiment of the present disclosure, as shown in FIG. 6, the modulation module 3 may further include a fifth carrier board 38, wherein the first carrier board 31 may be disposed between the fifth carrier board 38 and the second carrier board 32, and the fifth carrier board 38 and the first carrier board 31 may define a cavity 39. In the present disclosure, the first pattern layer 331 may be disposed in the cavity 39. Specifically, the first pattern layer 331, the ground layer 332 and the modulation carrier board 333 of the modulation module 3 may be disposed at any position in the cavity 39, so as to be protected by the first carrier board 31 and the fifth carrier board 38 for providing integrity and aesthetics, or preventing the first pattern layer 331 and the ground layer 332 from oxidation or corrosion, thereby increasing the product life. Here, the first pattern layer 331, the ground layer 332 and the modulation carrier board 333 may be stacked on each other and may be disposed on the first carrier board 31, but it is not limited thereto.

In addition, as shown in FIG. 6, the modulation module 3 may further include a first sealing member 61 and a second sealing member 62. The cavity 39 may be formed by being surrounded by the first carrier board 31, the fifth carrier board 38, the first sealing member 61 and the second sealing member 62, and the cavity 39 may be a vacuum or may contain air or an inert gas. The first sealing member 61 and the second sealing member 62 may each have a thickness T8 in the Z direction, and the thickness T8 may be between 6 mm and 12 mm, for example, about 6 mm, about 8 mm, about 10 mm or about 12 mm. In addition, in the Z direction, the thickness of the cavity 39 may be substantially the same as the thickness T8 of the first sealing member 61 and the second sealing member 62. In the present disclosure, the material of the first sealing member 61 and the second sealing member 62 may include aluminum or other suitable materials, but it is not limited thereto.

In another embodiment, although not shown, the first pattern layer 331, the ground layer 332 and the modulation carrier board 333 may also be stacked on each other and may be arranged on the fifth carrier board 38, that is, the first pattern layer 331 may be in contact with the fifth carrier board 38, but it is not limited thereto.

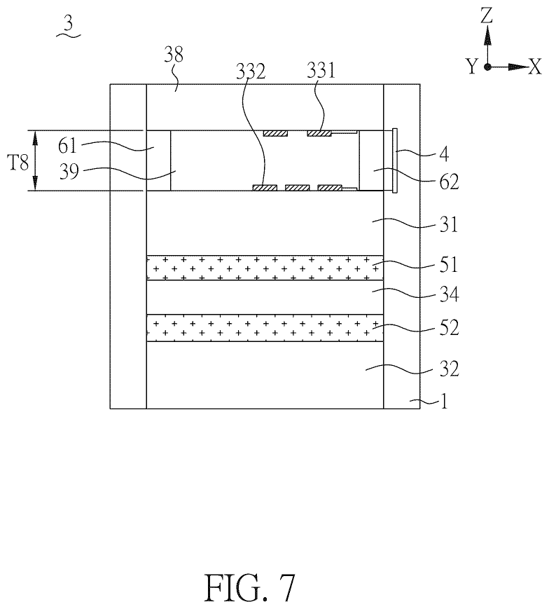

FIG. 7 is a cross-sectional schematic diagram of a modulation module according to another embodiment of the present disclosure. The modulation module of FIG. 7 is similar to FIG. 6 except for the following differences. In addition, for the convenience of explanation, some detailed structures of the electromagnetic wave adjusting element 34 of FIG. 7 are omitted, and the details may be referred to FIG. 2.

The modulation module 3 of the embodiment of FIG. 7 may include a first pattern layer 331 and a ground layer 332, wherein the first pattern layer 331 may be disposed on the fifth carrier board 38, and the ground layer 332 may be disposed on the first carrier board 31, so that the configuration of the modulation carrier board 333 may be reduced. In some embodiments, the thickness T8 may be adjusted according to the frequency of the signal to be received.

In one embodiment of the present disclosure, as shown in FIG. 7, the ground layer 332 of the modulation module 3 may be disposed on the first carrier board 31, and the ground layer 332 may be integrally disposed, which means that the ground layer 332 is disposed on the entire top surface 311 of the third carrier board 31.

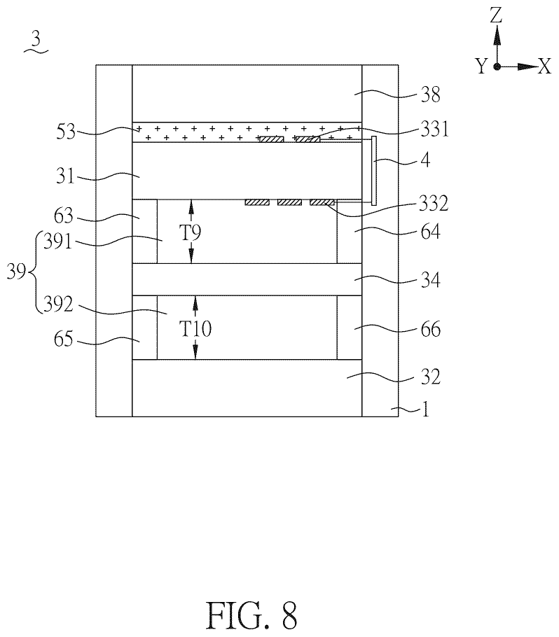

FIG. 8 is a cross-sectional schematic diagram of a modulation module according to another embodiment of the present disclosure. The modulation module of FIG. 8 is similar to that of FIG. 4 except for the following differences. In addition, for the convenience of explanation, some detailed structures of the electromagnetic wave adjusting element 34 of FIG. 8 are omitted, and the details may be referred to FIG. 2.

The modulation module 3 of the embodiment of FIG. 8 may further include a third adhesive layer 53, which may be disposed between the fifth carrier board 38 and the first carrier board 31. In addition, the modulation module 3 of the embodiment of FIG. 8 may further include a third sealing member 63, a fourth sealing member 64, a fifth sealing member 65, and a sixth sealing member 66, wherein the third sealing member 63 and the fourth sealing member 64 may be disposed between the first carrier board 31 and the electromagnetic wave adjusting element 34, and the fifth sealing member 65 and the sixth sealing member 66 may be disposed between the electromagnetic wave adjusting element 34 and the second carrier board 32. The modulation module 3 of the embodiment of FIG. 8 may further include a first cavity 391 and a second cavity 392, wherein the first cavity 391 may be formed by being surrounded by the first carrier board 31, the electromagnetic wave adjusting element 34, the third sealing member 63, and the fourth sealing member 64, and the second cavity 392 may be formed by being surrounded by the electromagnetic wave adjusting element 34, the second carrier board 32, the fifth sealing member 65, and the sixth sealing member 66. In the present disclosure, the first pattern layer 331 may be disposed on the first carrier board 31 and in the third adhesive layer 53, and the ground layer 332 may be disposed on one side of the first carrier board 31 adjacent to the electromagnetic wave adjusting element 34 and may be disposed in the first cavity 391.

In the present disclosure, the third sealing member 63 and the fourth sealing member 64 may each have a thickness T9 in the Z direction, and the thickness T9 may be between 6 mm and 12 mm, for example, about 6 mm, about 8 mm, about 10 mm, or about 12 mm. In addition, in the Z direction, the thickness of the first cavity 391 may be substantially the same as the thickness T9 of the third sealing member 63 or the fourth sealing member 64. In the present disclosure, the fifth sealing member 65 and the sixth sealing member 66 may each have a thickness T10 in the Z direction, and the thickness T10 may be between 6 mm and 12 mm, for example, about 6 mm, about 8 mm, about 10 mm, or about 12 mm. In addition, in the Z direction, the thickness of the second cavity 392 may be substantially the same as the thickness T10 of the fifth sealing member 65 or the sixth sealing member 66. In the present disclosure, the materials of the third sealing member 63, the fourth sealing member 64, the fifth sealing member 65, and the sixth sealing member 66 may include aluminum or other suitable materials, but it is not limited thereto.

In one embodiment of the present disclosure, although not shown in the figure, the first pattern layer 331 of the modulation module 3 may be disposed on one side of the third adhesive layer 53 away from the electromagnetic wave adjusting element 34, but it is not limited thereto.

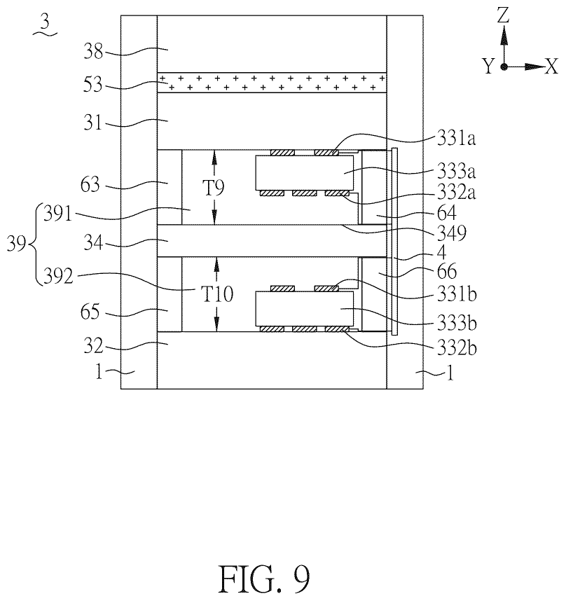

FIG. 9 is a cross-sectional schematic diagram of a modulation module according to another embodiment of the present disclosure. The modulation module of FIG. 9 is similar to that of FIG. 8 except for the following differences. In addition, for the convenience of explanation, some detailed structures of the electromagnetic wave adjusting element 34 of FIG. 9 are omitted, and the details may be referred to FIG. 2.

The modulation module 3 of the embodiment of FIG. 9 may include a first pattern layer 331a, a first ground layer 332a, and a first modulation carrier board 333a. The first pattern layer 331a, the first ground layer 332a and the first modulation carrier board 333a may be stacked on each other and may be disposed in the first cavity 391. In addition, the modulation module 3 of the embodiment of FIG. 9 may include a second pattern layer 331b, a second ground layer 332b, and a second modulation carrier board 333b. The second pattern layer 331b, the second ground layer 332b and the second modulation carrier board 333b may be stacked on each other and may be disposed in the second cavity 392.

In the present disclosure, the first pattern layer 331a may be disposed on one side of the first carrier board 31 adjacent to the electromagnetic wave adjusting element 34, and the second ground layer 332b may be disposed on one side of the second carrier board 32 adjacent to the electromagnetic wave adjusting element 34, but it is not limited thereto. The first pattern layer 331a, the first ground layer 332a and the first modulation carrier board 333a may be disposed at any position in the first cavity 391, and the second pattern layer 331b, the second ground layer 332b and the second modulation carrier board 333b may be disposed at any position in the second cavity 392. For example, in one embodiment, although not shown in the figure, the ground layer 332a may be disposed on one side of the electromagnetic wave adjusting element 34 adjacent to the first carrier board 31. In one embodiment, although not shown in the figure, the ground layer 332a of the modulation module 3 may be disposed between the liquid crystal layer 343 (as shown in FIG. 2) and the third carrier board 341 (as shown in FIG. 2). Specifically, the first electrode layer 346 (as shown in FIG. 2) of the electromagnetic wave adjusting element 34 is used as the ground layer 332a of the modulation module 3, so as to reduce the production of one electrode layer, thereby lowering the cost. In one embodiment, although not shown in the figure, the first pattern layer 331a of the modulation module 3 may be disposed on one side of the first carrier board 31 adjacent to the electromagnetic wave adjusting element 34, and the ground layer 332a may be disposed between the liquid crystal layer 343 (as shown in FIG. 2) and the third carrier board 341 (as shown in FIG. 2), thereby omitting the first modulation carrier board 333a. In one embodiment, although not shown in the figure, the ground layer 332a of the modulation module 3 may be disposed on one side of the electromagnetic wave adjusting element 34 adjacent to the first carrier board 31, and is integrally disposed on the entire surface, which means that the ground layer 332 is provided on the entire top surface 349 of the electromagnetic wave adjusting element 34.

In this embodiment, the remaining features of the first pattern layer 331a, the first ground layer 332a, the first modulation carrier board 333a, the second pattern layer 331b, the second ground layer 332b and the second modulation carrier board 333b may refer to the aforementioned first pattern layer 331, the ground layer 332 and the modulation carrier board 333, and thus will not be repeated here.

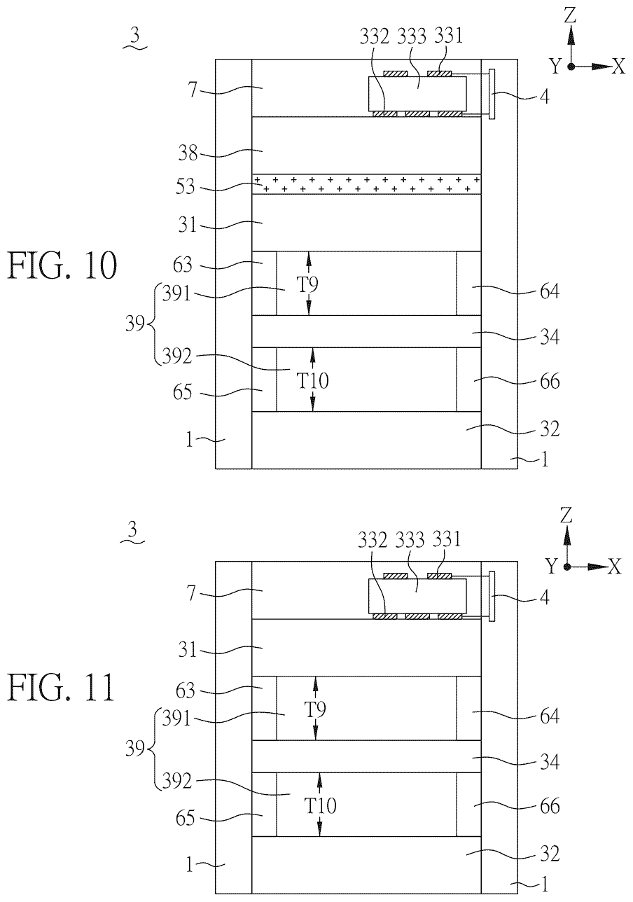

FIG. 10 is a cross-sectional schematic diagram of a modulation module according to another embodiment of the present disclosure. The modulation module of FIG. 10 is similar to that of FIG. 8 except for the following differences. In addition, for the convenience of explanation, some detailed structures of the electromagnetic wave adjusting element 34 of FIG. 10 are omitted, and the details may be referred to FIG. 2.

The first pattern layer 331, the ground layer 332 and the modulation carrier board 333 of the modulation module 3 according to the embodiment of FIG. 10 may be stacked on each other and may be disposed on the fifth carrier board 38. In addition, for aesthetics and protection, the modulation module 3 of the embodiment of FIG. 10 may further include a cover plate 7, which is disposed on the fifth carrier board 38 and covers the first pattern layer 331, the ground layer 332 and the modulation carrier board 333. The material of the cover plate 7 may include polycarbonate (PC), polymethylmethacrylate (PMMA) or a combination thereof.

FIG. 11 is a cross-sectional schematic diagram of a modulation module according to another embodiment of the present disclosure. The modulation module of FIG. 11 is similar to that of FIG. 10 except for the following differences. In addition, for the convenience of explanation, some detailed structures of the electromagnetic wave adjusting element 34 of FIG. 11 are omitted, and the details may be referred to FIG. 2.

The modulation module 3 of the embodiment of FIG. 11 may not be provided with the third adhesive layer 53 and the fifth carrier board 38. The first pattern layer 331, the ground layer 332 and the modulation carrier board 333 may be stacked on each other and may be arranged on one side of the first carrier board 31 opposite to the electromagnetic wave adjusting element 34.

In the present disclosure, the materials of the first carrier board 31, the second carrier board 32, the third carrier board 341, the fourth carrier board 342, the fifth carrier board 38, the modulation carrier board 333, the first modulation carrier board 333a and/or the second modulation carrier board 333b may include a rigid substrate, a soft substrate or a flexible substrate. The materials of the first carrier board 31, the second carrier board 32, the third carrier board 341, the fourth carrier board 342, the fifth carrier board 38, the modulation carrier board 333, the first modulation carrier board 333a and/or the second modulation carrier board 333b may be the same or different. The materials of the first carrier board 31, the second carrier board 32, the third carrier board 341, the fourth carrier board 342, the fifth carrier board 38, the modulation carrier board 333, the first modulation carrier board 333a and/or the second modulation carrier board 333b may each include glass, quartz, sapphire, ceramic, plastic, polycarbonate (PC), polyimide (PI), polypropylene (PP), polyethylene terephthalate (PET), polymethylmethacrylate (PMMA), other suitable materials or a combination of the above materials, but it is not limited thereto.

In the present disclosure, the materials of the conductive wire 4, the first pattern layers 331 and 331a, the second pattern layer 331b, the ground layer 332, the first ground layer 332a, the second ground layer 332b, the first electrode layer 346 and/or the second electrode layer 347 may be the same or different from each other. The materials of the conductive wire 4, the first pattern layers 331, 331a, the second pattern layer 331b, the ground layer 332, the first ground layer 332a, the second ground layer 332b, the first electrode layer 346 and/or the second electrode layer 347 may each include a transparent conductive material (for example, indium zinc oxide (IZO), indium tin oxide (ITO), indium tin zinc oxide (ITZO), indium gallium zinc oxide (IGZO), aluminum zinc oxide (AZO)), a non-transparent conductive material (for example, gold, silver, copper) or a combination thereof, but it is not limited thereto.

In the present disclosure, the materials of the first adhesive layer 51, the second adhesive layer 52 and/or the third adhesive layer 53 may each include, for example, polyvinyl butyral (PVB), ethylene vinyl acetate (EVA), optical clear adhesive (OCA), optical clear resin (OCR), other suitable materials or a combination thereof, but it is not limited thereto.

In the present disclosure, since the electromagnetic wave receiving element 33 in the modulation module 3 or the electronic device including the same is adjacent to the outdoor side, the signal will not be affected by the building or the electrode layer, which may improve the signal strength and stability indoors. In addition, the first pattern layer 331 and 331a, the second pattern layer 331b, the ground layer 332, the first ground layer 332a and the second ground layer 332b in the modulation module 3 may be protected by the first carrier board 31, the second carrier board 32 and the fifth carrier board 38, which may prevent the aforementioned pattern layers and the ground layers from being oxidized or corroded, thereby improving the product life.

The aforementioned specific embodiments should be interpreted as merely illustrative, and not limiting the rest of the present disclosure in any way.

1. An electronic device, comprising:
a frame including an accommodation space and a frame groove arranged to be adjacent to the accommodation space;
a signal connection element disposed in the frame groove; and
a modulation module disposed in the accommodation space, including:
a first carrier board;
a second carrier board corresponding to the first carrier board;
an electromagnetic wave receiving element disposed on at least one of the first carrier board and the second carrier board; and
an electromagnetic wave adjusting element disposed between the first carrier board and the second carrier board,
wherein the electromagnetic wave receiving element is electrically connected to the signal connection element in the frame groove.

2. The electronic device as claimed in claim 1, further comprising a conductive wire passing through the frame to connect the signal connection element and the electromagnetic wave receiving element.

3. The electronic device as claimed in claim 2, wherein the electromagnetic wave receiving element includes a first pattern layer disposed on the first carrier board and connected to the conductive wire.

4. The electronic device as claimed in claim 2, wherein the modulation module includes a ground layer connected to the conductive wire.

5. The electronic device as claimed in claim 1, wherein the frame groove includes a first sub-frame groove and a second sub-frame groove, the signal connection element includes a first sub-device and a second sub-device, the first sub-device is arranged in the first sub-frame groove, and the second sub-device is arranged in the second sub-frame groove.

6. The electronic device as claimed in claim 3, wherein the modulation module further includes a modulation carrier board arranged between the first pattern layer and a ground layer of the modulation module.

7. The electronic device as claimed in claim 1, wherein the modulation module further includes a first adhesive layer and a second adhesive layer, the first adhesive layer is disposed between the first carrier board and the electromagnetic wave adjusting element, and the second adhesive layer is disposed between the electromagnetic wave adjusting element and the second carrier board.

8. The electronic device as claimed in claim 1, wherein the electromagnetic wave adjusting element includes a liquid crystal layer, a third carrier board and a fourth carrier board, the fourth carrier board corresponds to the third carrier board, the third carrier board and the fourth carrier board are disposed between the first carrier board and the second carrier board, and the liquid crystal layer is disposed between the third carrier board and the fourth carrier board.

9. The electronic device as claimed in claim 1, wherein the liquid crystal layer further includes a liquid crystal material and a liquid crystal spacer dispersed in the liquid crystal material.

10. The electronic device as claimed in claim 3, wherein the modulation module further includes a fifth carrier board, the first carrier board is disposed between the fifth carrier board and the second carrier board, the fifth carrier board and the first carrier board define a cavity, and the first pattern layer, the ground layer and the modulation carrier board are disposed in the cavity.

11. The electronic device as claimed in claim 1, wherein the frame groove includes a first sub-frame groove and a second sub-frame groove, the signal connection element includes a hub and a customer premise equipment, the hub is disposed in the first sub-frame groove, the customer premise equipment is disposed in the second sub-frame groove, and the first sub-frame groove is disposed between the accommodation space and the second sub-frame groove.

12. The electronic device as claimed in claim 8, wherein the electromagnetic wave adjusting element further includes a first electrode layer and a second electrode layer, the first electrode layer is disposed between the third carrier board and the liquid crystal layer, and the second electrode layer is disposed between the liquid crystal layer and the fourth carrier board.

13. A modulation module, comprising:
a first carrier board;
a second carrier board corresponding to the first carrier board;
a liquid crystal layer disposed between the first carrier board and the second carrier board;
an electromagnetic wave receiving element including a first pattern layer; and
a ground layer corresponding to the first pattern layer,
wherein the first pattern layer is disposed on the first carrier board, and the ground layer is closer to the liquid crystal layer than the first pattern layer.

14. The modulation module as claimed in claim 13, further comprising a third carrier board and a fourth carrier board, wherein the fourth carrier board corresponds to the third carrier board, the third carrier board and the fourth carrier board are disposed between the first carrier board and the second carrier board, and the liquid crystal layer is disposed between the third carrier board and the fourth carrier board.

15. The modulation module as claimed in claim 14, wherein the ground layer is disposed between the liquid crystal layer and the third carrier board.

16. The modulation module as claimed in claim 14, wherein an area of the ground layer is as same as an area of the third carrier board.

17. The modulation module as claimed in claim 14, wherein a thickness of the third carrier board or the fourth carrier board is smaller than a thickness of the first carrier board or the second carrier board.

18. The modulation module as claimed in claim 13, further comprising a fifth carrier board, wherein the first carrier board is disposed between the fifth carrier board and the second carrier board, and the fifth carrier board and the first carrier board define a cavity.

19. The modulation module as claimed in claim 18, wherein the first pattern layer is disposed in the cavity.

20. The modulation module as claimed in claim 13, wherein the liquid crystal layer further includes a liquid crystal material and a liquid crystal spacer dispersed in the liquid crystal material.
